(19) United States
(12) Patent Application Publication
(10) Pub. No.: US 2012/0204399 A1
(43) Pub. Date: Aug. 16, 2012

(54) METHOD OF REMOVING PANELS

(76) Inventor: W. Frank Little, JR., Magnolia, TX (US)

(21) Appl. No.: 13/370,150

(22) Filed: Feb. 9, 2012

Related U.S. Application Data
(60) Provisional application No. 61/441,583, filed on Feb. 10, 2011.

(51) Int. Cl. E04G 23/00; E04G 23/06; B23P 11/00

(52) U.S. Cl. 29/426.4; 29/426.1; 29/426.5

(57) ABSTRACT

A method of removing a wall assembly may comprise removing a first panel from the wall assembly to thereby exposing a space between a backside of a second panel and an outer surface of a support member. The second panel may be secured to the support member by a fastening member. The method may further comprise introducing a tool into the space and releasing the second panel from engagement with the support member using the tool. The second panel may be removed in a manner that it is in condition for reuse in the construction of another wall assembly.

### CROSS REFERENCE TO RELATED APPLICATION

This application claims benefit of U.S. Provisional Application No. 61/441,583, filed Feb. 10, 2011, the contents of which are herein incorporated by reference in its entirety.

### BACKGROUND OF THE INVENTION

1. Field of the Invention

Embodiments of the invention generally relate to a method of removing one or more panels of a wall assembly. The wall assembly may be constructed from one or more panels that are secured to one or more support elements using one or more fastening members. At least one of the panels may be effectively removed from the wall assembly in a manner that it may be re-used for the construction of another wall assembly or another structure.

2. Description of the Related Art

In the construction of walls or partitions, for use in homes and buildings, sheets of drywall are often secured to wooden studs to support the wall. The drywall sheets are typically prefabricated sheets of various sizes. A common sheet of drywall is four feet wide by eight feet in length. These drywall sheets are fastened to the wooden studs in a manner that creates a substantially planar surface having joints at some of the drywall sheet edges. In order to finish the wall and create a smooth surface it is often necessary to apply a tape to the joint and then cover the tape with a compound, such as mud. Once dry, the compound is smoothed to a seamless surface and then may be covered with a surface finishing, such as paint.

More recently, the idea of “green building” has attracted the attention of the community in the construction industry. The green building concept is the practice of creating structures and using processes that are environmentally responsible and resource-efficient throughout the life of a building's design, from inception to construction and maintenance, and extending to deconstruction. The Leadership in Energy & Environmental Design (“LEED”) is an internationally recognized green building certification system that verifies whether a building's design was constructed using strategies intended to improve performance in metrics such as energy savings and stewardship of resources. LEED certified buildings often provide healthier work and living atmospheres, while minimizing any negative environmental impacts on society.

With the increased demand and awareness of green building, it is extremely advantageous to have the ability to reuse existing building materials. However, with respect to wall deconstruction, it is difficult to remove a drywall sheet from a wall assembly without destroying it. The time and resources necessary to deconstruct a wall for reuse may far outweigh any advantage of reuse in some circumstances.

Therefore, there is a need for an efficient and economical method for removing one or more panels for reuse during the deconstruction of a wall assembly.

### SUMMARY OF THE INVENTION

In one embodiment, a method of removing a wall assembly may comprise removing a first panel from the wall assembly, thereby exposing a space between a backside of a second panel and an outer surface of a support member. The second panel is secured to the support member by a fastening member that is disposed through the second panel and the support member. The method may further comprise introducing a tool into the space to engage the fastening member and severing the fastening member, thereby releasing the second panel from engagement with the support member such that the second panel is in a condition for reuse in the construction of another wall assembly.

In one embodiment, a method of removing a wall assembly may comprise removing a first panel from the wall assembly, thereby exposing a space between a backside of a second panel and an outer surface of a support member. The second panel is secured to the support member. The method may further comprise introducing a tool into the space and releasing the second panel from engagement with the support member using the tool in a manner that the second panel is in a condition for reuse in the construction of another wall assembly.

In one embodiment, a method of removing a wall assembly, wherein the wall assembly includes a first wall having a first panel, a second panel, and a third panel, wherein the wall assembly includes a second wall having a fourth panel and a fifth panel, and wherein the first and second walls are supported by and on opposite sides of a first support member, a second support member, and a third support member, the method comprising: removing the first panel from the first support member, wherein the first panel forms a joint with the second panel that is secured to the first support member, wherein the second panel forms a joint with the third panel that is secured to the third support member, wherein the fourth panel forms a joint with the fifth panel that is secured to the second support member, and wherein the second support member is located between the first and second support members; exposing a space between the fourth panel and the first support member, wherein the fourth panel is secured to the first support member on a side opposite the first and second panels; introducing a tool into the space; releasing the fourth panel from engagement with the first support member using the tool in a manner that the fourth panel is in a condition for reuse in the construction of another wall assembly; and exposing the joint formed between the fourth panel and the fifth panel that is secured to the second support member.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D illustrate a method of removing a wall assembly according to one embodiment.

FIG. 1E illustrates the wall assembly of FIG. 1A showing panel joints of each wall connected to the same support members according to one embodiment.

FIG. 2 illustrates a top cross-sectional view of a support member of the wall assembly according to one embodiment.

FIG. 3 illustrates the wall assembly showing panel joints of each wall connected to support members in a staggered configuration according to one embodiment.

### DETAILED DESCRIPTION

Embodiments of the invention include a method of removing one or more panels of a wall assembly in a manner that the removed panel may be reused to construct another wall assembly. The wall assembly may be constructed of one or more panels that are supported by support elements. The panels may be secured to the support elements by one or more fastening members.

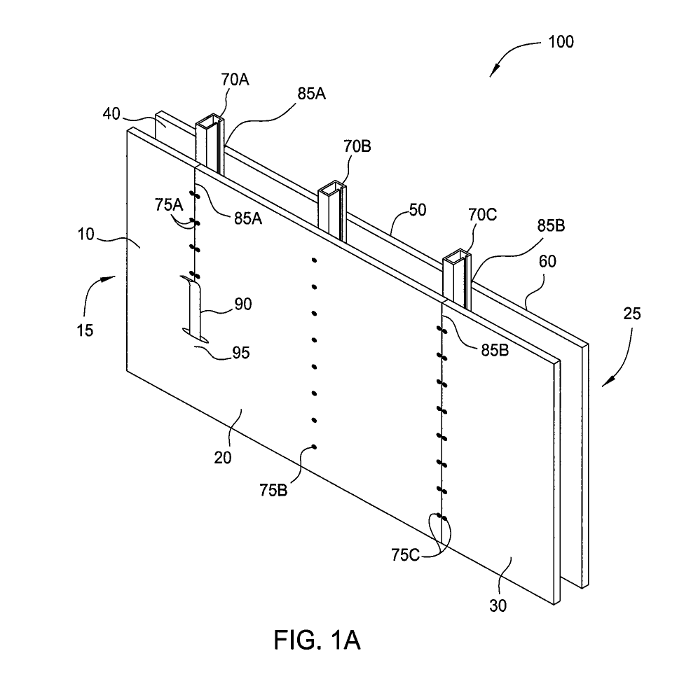

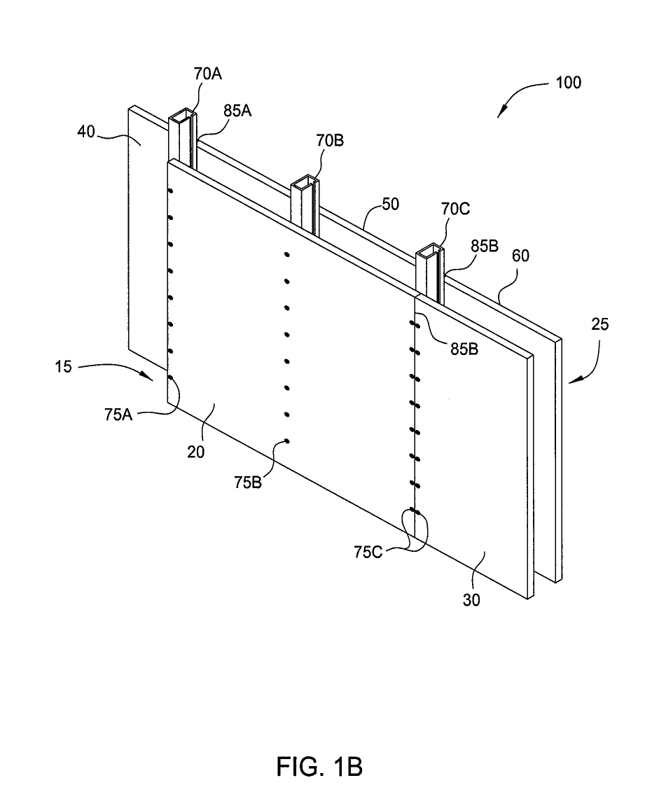

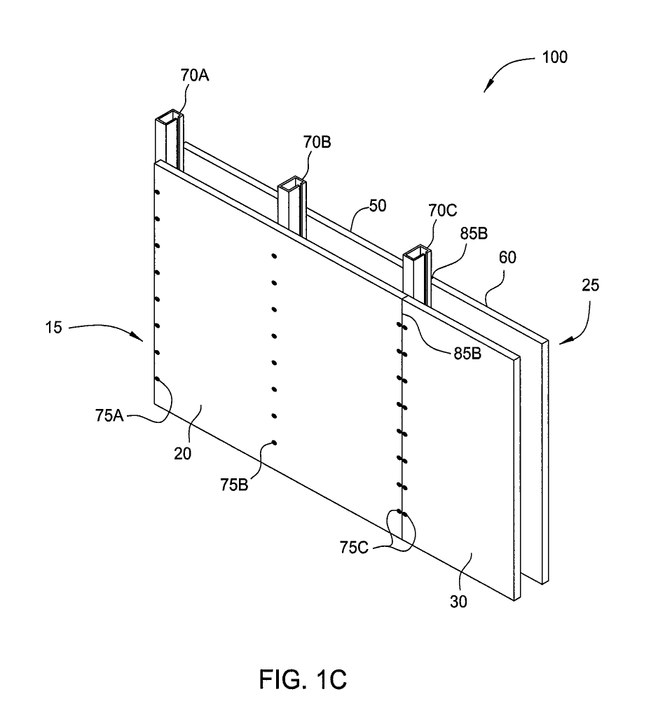

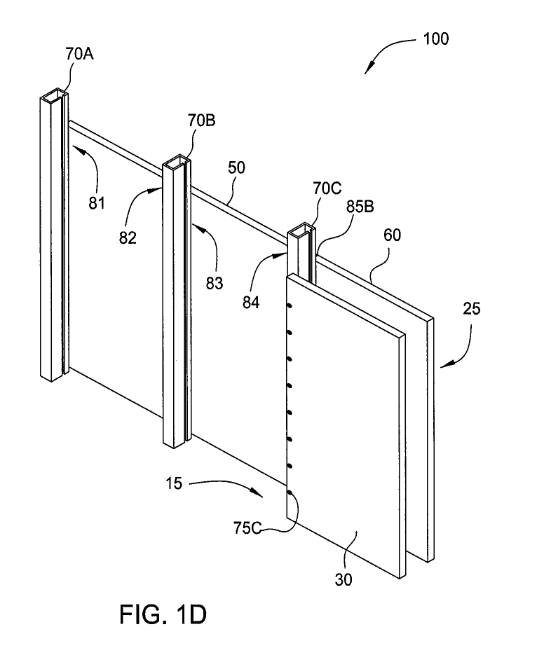

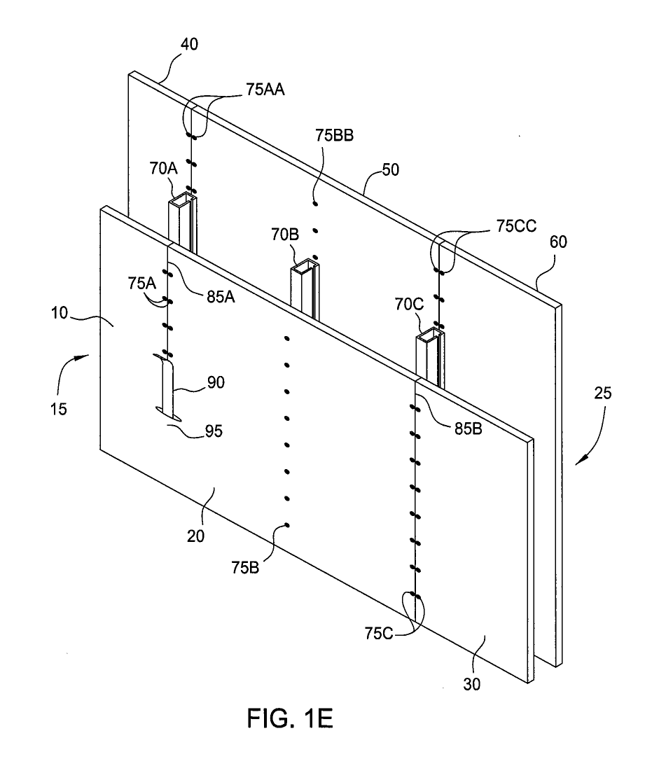

FIG. 1A illustrates a wall assembly 100 that includes a first panel 10, a second panel 20, and a third panel 30. The first, second, and third panels 10, 20, 30 are secured together to form a first wall 15. The wall assembly 100 also includes a fourth panel 40, a fifth panel 50, and a sixth panel 60. The fourth, fifth, and sixth panels 40, 50, 60 are secured together to form a second wall 25. The first and second walls 15, 25 are supported by one or more support elements 70A, 70B, and 70C. The support elements 70A, 70B, 70C are illustrated in FIG. 1A as having a height that is greater than the height of the first and second walls 15, 25, however, in other embodiments, the support elements 70A, 70B, and 70C may be completely hidden behind the first and second walls 15, 25.

The first and second walls 15, 25 are similarly supported on opposite sides of the support elements 70A, 70B, and 70C. In particular, the edges of the first and second panels 10, 20 are secured in abutting fashion to the support element 70A via one or more fastening members 75A. The edges of the second and third panels 20, 30 are also secured in abutting fashion to the support element 70C via one or more fastening members 75C. A central portion of the second panel 20 may be secured to the support member 70B via one or more fastening members 75B. The fourth, fifth, and sixth panels 40, 50, 60 of the second wall 25 may similarly be secured to the respective support elements 70A, 70B, 70C via fastening members 75AA, 75BB, 75CC (visible in FIG. 1E) that are on the side opposite fasteners 75A, 75B, 75C shown in FIG. 1A of respective support elements 70A, 70B, 70C. FIG. 1E illustrates the wall assembly 100 of FIG. 1A showing panel joints of each wall 15, 25 connected to the same support members according to one embodiment. In FIG. 1E, the first wall 15 and the support members 70A, 70B, 70C are reduced in height for illustration of the parallel arrangement of the joints between the first and second walls 15, 25 and the support members 70A, 70B, 70C.

In one embodiment, the panels 10, 20, 30, 40, 50, 60 may comprise one or more types of building material known in the art, including wood, metal, plaster, concrete, brick, etc. In one embodiment the panels 10, 20, 30, 40, 50, 60 may be drywall panels. In one embodiment, the support elements 70A, 70B, 70C may comprise one or more types of building supports known in the art, including wooden studs, metallic studs, concrete blocks, furring channels, etc. In one embodiment, the fastening members 75A, 75B, 75C, 75AA, 75BB, 75CC may comprise one or more types of fasteners known in the art, including screws, nails, tacks, adhesives, etc.

In one embodiment, the first and second panels 10, 20 may be attached to the support element 70A such that a gap 85A exists between the abutting edges of the panels along the height of the panels. A tape 90 and a compound 95 may be applied to the first wall 15 at the gap 85A. The tape 90 may be configured to cover the gap 85A and the fastening members 75A across the entire height of the first and second panels 10, 20. For illustrative purposes, the gap 85A is shown partially covered in FIG. 1A only. A portion of the tape 90 may be left uncovered and/or exposed from the compound 95 to assist in removal of the first wall 15 as described in U.S. patent application Ser. No. 11/679,069, filed Feb. 26, 2007, and in U.S. Pat. No. 7,197,853, the embodiments of which are herein incorporated by reference in their entirety. Once the tape 90 is applied to the first wall 15, the compound 95 is applied over the tape 90 and the fastening members 75A to form a smooth continuous planar surface. The first wall 15 may then be provided with any type of surface finishing known in the art, including painting, texturizing, wallpapering, covering with fabric, wood, plastic, plastic laminate, or linoleum, etc. A similar process may be performed to cover the fastening members 75B and at a gap 85B formed between the abutting edges of the second and third panels 20, 30. The panels of the second wall 25 may also be completed in a similar manner.

When it is desired to remove the wall assembly 100, any one of the panels of the first or second walls 15, 25 may be removed in any manner known by one skilled in the art to thereby expose the fastening members that are used to secure the adjacent panels. In one embodiment, any one of the panels of the first and/or second walls 15, 25 may be removed using one or more of the removal methods described in U.S. patent application Ser. No. 11/679,069, filed Feb. 26, 2007, and in U.S. Pat. No. 7,197,853, the embodiments of which are herein incorporated by reference in their entirety. In one embodiment, the panel that is removed first from the wall assembly 100 may be removed in a manner that the panel is reusable or may simply be destroyed during removal.

FIG. 1B illustrates the wall assembly 100 after the removal of the first panel 10. When the first panel 10 is removed, the fastening members 75A that are used to secure the second panel 20 to the support member 70A are exposed so that they are more easily accessible with one or more tools that can be utilized to remove the remaining panels without destroying them so that they can be reused to construct another wall assembly. The fastening members 75AA that are used to secure the fourth panel 40 to the support member 70A are also more easily accessible from the backside of the second wall 25.

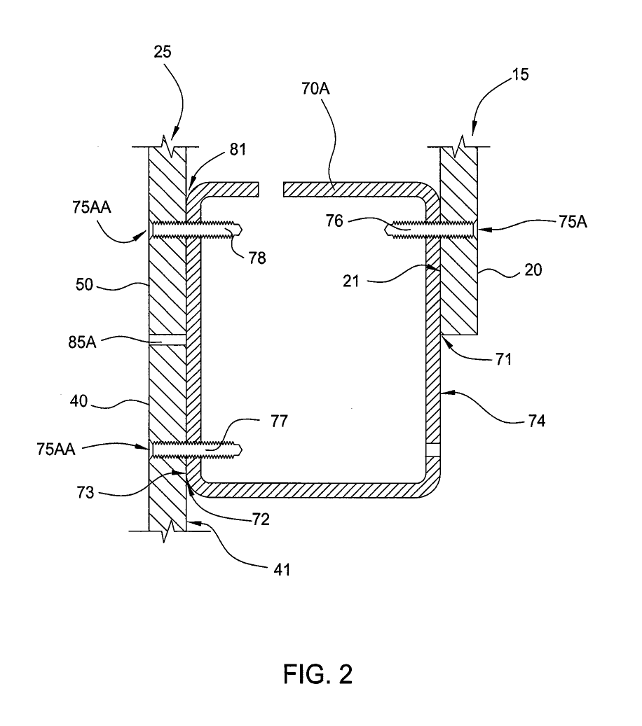

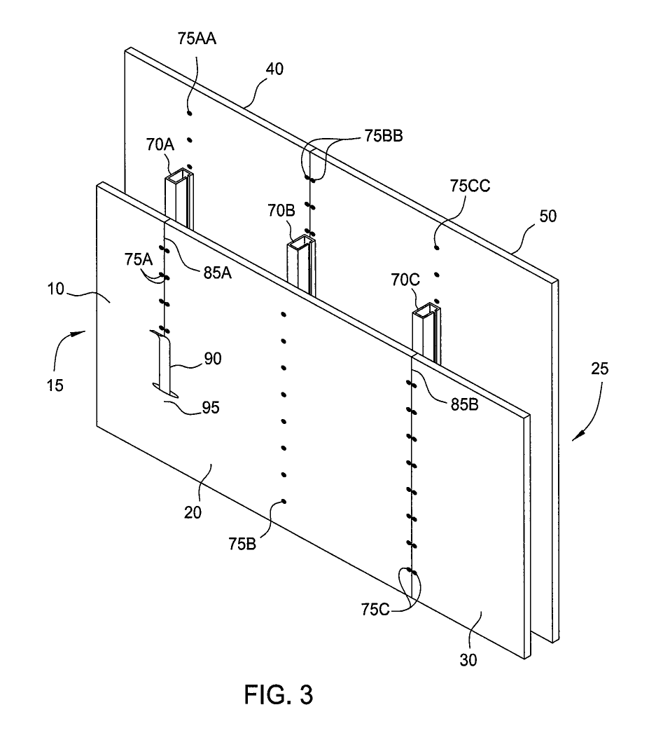

FIG. 2 illustrates a top cross-sectional view of the support member 70A with the first panel 10 removed. As illustrated, a space 71 between a back surface 21 of the second panel 20 and an outer surface 74 of the support member 70A can be used to access a body 76 of the fastening member 75A to facilitate removal of the second panel 20 from the support member 70A. Further illustrated, is a space 72 between a back surface 41 of the fourth panel 40 and an outer surface 73 of the support member 70A that can be used to access a body 77 of the fastening member 75AA to facilitate removal of the fourth panel 40 from the support member 70A. Then a panel member space 85A may be used to access a body 78 of the fastening member 75AA that is used to secure the fifth panel 50 to the support member 70A. Either panel 20, 40 can be removed subsequent to removal of the first panel 10. FIG. 2 further illustrates the panel member space 85A on wall 25. FIG. 3 (further described below) illustrates that the panel member joints of wall 15 and the panel member joint of wall 25 are not directly attached to the same support member 70A, 70B, 70C, but rather are staggered so as to avoid direct joint connection of both wall 15 and wall 25 on the same support member. In FIG. 3, the joint connection of wall 25 occurs at support member 70B, and not 70A or 70C, while the joint connections of wall 15 occur at support members 70A, 70C, and not 70B. Embodiments of the invention include the severing and/or prying, release and removal method described herein, as well as staggering of the panel member joint connections to allow a simple repetitive disassembly unknown in the art.

In one embodiment, a cutting tool may be introduced into the space 71 to cut the body 76 of each fastening member 75A to separate the second panel 20 from the support member 70A without significantly damaging the second panel 20 so that it can be reused to construct another wall assembly. For example, the blade of a reciprocating saw can be moved into the space 71 to access and cut the body 76 of each fastening member 75A to separate the second panel 20 from the support member 70A, without significant destruction (such that the panel can be reused to construct another wall assembly), if any, of the second panel 20. In one embodiment, a cutting tool may be introduced into space 72 and used to sever one or both of the bodies 77, 78 of the fastening members 75AA, thereby releasing the fourth and fifth panels 40, 50 from the support member 70A. In one embodiment, a hand tool may be introduced into the space 71 to pry the body 76 of each fastening member 75A and/or the second panel 20 from the support member 70A so that the second panel 20 is reusable to construct another wall assembly. For example, a flat-blade crowbar can be used to separate the second panel 20 from the support member 70A without significantly demolishing the second panel 20. Once the second panel 20 is released from the support member 70A, the second panel 20 can be moved to provide access to the fastening members 75B that secure the remaining portion of the second panel 20 to the support member 70B to perform similar removal steps. Once the second panel 20 is released from the support member 70B, the second panel 20 can be further moved to provide access to the fastening members 75C that secure the remaining portion of the second panel 20 to the support member 70C to perform similar removal steps. In one embodiment, the fastening members 75B and/or 75C may be an adhesive material, and the second panel 20 may be pried and/or pulled from its engagement with the support members 70B, 70C without destroying the second panel 20. The third, fourth, fifth and/or sixth panels 30, 40, 50, 60 can be removed in a similar manner. Furthermore, in one embodiment, with joints of wall 15 and wall 25 staggered so as to not be on the same support member as illustrated in FIG. 3, once the first panel 10 is released and removed from the support member 70A, the fastening members 75AA of the fourth panel 40 can be easily accessed from the backside of fourth panel 40 and severed and/or pried to disengage fourth panel 40 from support member 70A; then fourth panel 40 can be moved to provide access to the fastening members 75BB. In one embodiment, the fourth panel 40 utilizes methods described in U.S. patent application Ser. No. 11/679,069, filed Feb. 26, 2007, and in U.S. Pat. No. 7,197,853 (the contents of which are herein incorporated by reference in their entirety), at the joint between fourth panel 40 and fifth panel 50 to access fasteners 75BB for removal to release fourth panel 40 from support member 70B. The remaining panels may be removed by performing similar removal steps.

FIG. 1C illustrates the wall assembly 100 after the removal of the first and fourth panels 10, 40. The second or fifth panels 20, 50 may subsequently be removed in any order. FIG. 1D illustrates the wall assembly 100 after removal of the second panel 20, which exposes the backside of the second wall 25 and provides access to the remaining fastening members 75A, 75AA, 75B, 75BB, 75C, 75CC via spaces 81, 82, 83, 84 to facilitate removal of the third, fifth, and sixth panels 30, 50, 60. The third, fifth, and sixth panels 30, 50, 60 can be removed from the wall assembly 100 in any order and in a condition for reuse with another wall assembly similar to the first, second, and/or fourth panels 10, 20, 40. Furthermore, in one embodiment, with joints of wall 15 and wall 25 staggered so as to not be on the same support member as illustrated in FIG. 3, with the first panel 10 and the second panel 20 removed from the support members 70A, 70B, 70C the fastening members 75AA, 75BB, and 75CC can be easily accessed from the backside of panels 40, 50; and severed and/or pried to disengage wall 25 panels from support members; then the third panel 30 can be accessed from the backside to provide access to the remaining fastening members. In one embodiment, the walls 15, 25 panel members utilize methods described in U.S. patent application Ser. No. 11/679,069, filed Feb. 26, 2007, and in U.S. Pat. No. 7,197,853 (the contents of which are herein incorporated by reference in their entirety), at the joint between panels, and backside access to fasteners at intermediate studs is provided by alternately removing one panel one from wall 15, then one panel from wall 25, then one panel from wall 15 and so on. The remaining panels may be removed by performing similar removal steps

In one embodiment, the wall assembly 100 shown in FIG. 1 may be deconstructed in the following manner. First, the first panel 10 may be removed in any manner known by one of ordinary skill in the art, such that the first panel 10 may or may not be reusable. Removal of the first panel 10 exposes the backside of the second wall 25, as well as the fastening members 75A that are used to secure the second panel 20 and fasteners 75AA that are used to secure the fourth panel 40 to the support member 70A. Second, the fastening members 75AA that secure the fourth panel 40 to the support member 70A may be accessed by a space between the backside of the fourth panel 40 and the outer surface of the support member 70A, and may be severed and/or pried to release the fourth panel 40 from the support member 70A. By severing the fastening members 75AA within the space, the fourth panel 40 may be preserved in a condition for use in the construction of another wall assembly. Removal of the fourth panel 40 also exposes the fastening members 75AA that are used to secure the fifth panel 50 to the support member 70A. Third, the fastening members 75A that secure the second panel 20 to the support member 70A may be accessed by a space between the backside of the second panel 20 and an outer surface of the support member 70A, and may be severed to release the second panel 20 from the support member 70A. Removal of the second panel 20 from the support member 70A exposes the fastening members 75B that are used to secure the second panel 20 to the support member 70B. The second panel 20 may similarly be separated from its engagement with the support member 70B without significant destruction of the second panel 20, such that the second panel 20 may be reused. Removal of the second panel 20 from the support member 70B exposes the fastening members 75C that are used to secure the remaining portion of the second panel 20 to the support member 70C. The second panel 20 may similarly be separated from its engagement with the support member 70C without significant destruction of the second panel 20. Finally, removal of the second panel 20 from the wall assembly 100 exposes the backside of the second wall 25 and provides access to the remaining fastening members 75AA, 75BB, 75CC that are used to secure the third, fifth, and sixth panels 30, 50, 60 to the support members 70A, 70B, 70C. The third or fifth panels 30, 50 may be removed after the second panel 20; and the sixth panel 60 may be removed after removal of at least one of the third and fifth panels 30, 50. Further, use of methods described in U.S. patent application Ser. No. 11/679,069, filed Feb. 26, 2007, and in U.S. Pat. No. 7,197,853 (the contents of which are herein incorporated by reference in their entirety), can be used in conjunction with the sever and/or pry release and removal methods described herein to expedite deconstruction such that a maximum number of panels are reusable.

FIG. 3 illustrates one embodiment of the wall assembly 100 having the first and second panels 10, 20 forming a joint at and secured to the first support member 70A with one or more fasteners 75A. The second and third panels 20, 30 form a joint at and are secure to the third support member 70C with one or more fasteners 75C. The first, second, and third panels 10, 20, 30 form the first wall 15. The fourth and fifth panels 40, 50 form a joint at and are secured to the second support member 70B with one or more fasteners 75BB. The fourth and fifth panels 40, 50 form the second wall 25, which is disposed on a side of the support members opposite the first wall 15. The first wall 15 and the support members 70A, 70B, 70C are reduced in height for illustration of the staggered arrangement of the joints between the first and second walls 15, 25 and the support members 70A, 70B, 70C. As illustrated, the second panel 20 forms joints with the first and third panels 10, 30 at the first and third support members 70A, 70C but not at the second support member 70B, which contains the joint formed by the fourth and fifth panels 40, 50. One or more fastening members 75B may be used to secure the second panel 20 to the second support member 70B. Similarly, the fourth and fifth panels 40, 50 form the joint at the second support member 70B but not at the first and third support members 70A, 70C, which contain the joints formed by the first, second, and third panels 10, 20, 30, respectively. After removal of the first panel 10, the backside of the second panel 20 and thus the fastening members 75A may be exposed for ease of removal without damage to the second panel 20. The backside of the fourth panel 40 and thus the fastening members 75AA may be exposed for ease of removal of the fourth panel 40 such that the fourth panel 40 can be reused. Removal of the first, second, and/or fourth panels 10, 20, 30 provides access to the backside of the third and/or fifth panels 30, 50 and thus exposes the fastening members 75B, 75BB, 75C, 75CC for ease of removal of the third and fifth panels 30, 50 such that the panels can be reused. The removal of the panels of the walls 15, 25 may be performed in an alternating order or in any other order using the embodiments described herein.

In one embodiment, the wall assembly 100 may be deconstructed by alternately removing one panel from the first wall 15 and then one panel from the second wall 25, or vice versa. In one embodiment, the wall assembly 100 may be deconstructed so that all of the panels are reusable. In one embodiment, the wall assembly 100 may be deconstructed in a manner that certain panels are destroyed while other panels are reusable.

While the foregoing is directed to embodiments of the invention, other and further embodiments of the invention may be devised without departing from the basic scope thereof, and the scope thereof is determined by the claims that follow.

1. A method of removing a wall assembly, comprising:
removing a first panel from the wall assembly, thereby exposing a space between a backside of a second panel and an outer surface of a support member, wherein the second panel is secured to the support member by a fastening member;
introducing a tool into the space to engage the fastening member; and
severing the fastening member, thereby releasing the second panel from engagement with the support member such that the second panel is in a condition for reuse in the construction of another wall assembly.

2. The method of claim 1, wherein the first panel was secured to a side of the support member adjacent the second panel.

3. The method of claim 2, wherein the first panel was removed from engagement with the support member in a condition for reuse in the construction of another wall assembly.

4. The method of claim 3, wherein the wall assembly includes a first wall comprising one or more first panels secured to one or more support members, and a second wall comprising one or more second panels secured to the support members, wherein the first and second walls are disposed on opposite sides of the support members.

5. The method of claim 1, further comprising removing the second panel, thereby exposing a space between a backside of a third panel and an outer surface of the support member, wherein the third panel is secured to the support member by a fastening member.

6. The method of claim 5, wherein an outer surface of the first and third panels formed a continuous wall surface of the wall assembly prior to removal of the first panel.

7. The method of claim 6, further comprising introducing a tool into the space to engage and sever the fastening member, thereby releasing the third panel from engagement with the support member such that the third panel is in a condition for reuse in the construction of another wall assembly.

8. The method of claim 1, wherein the tool includes a cutting member for severing the fastening member.

9. The method of claim 1, wherein the first and second panels comprise at least one of wood, metal, plaster, concrete, and brick.

10. The method of claim 1, wherein the first and second panels comprise drywall.

11. The method of claim 1, wherein the support member includes at least one of wooden studs, metallic studs, concrete blocks, and furring channels.

12. The method of claim 1, wherein the fastening member includes at least one of screws, nails, adhesive, and tacks.

13. A method of removing a wall assembly, comprising:
removing a first panel from the wall assembly, thereby exposing a space between a backside of a second panel and an outer surface of a support member, wherein the second panel is secured to the support member;
introducing a tool into the space; and
releasing the second panel from engagement with the support member using the tool in a manner that the second panel is in a condition for reuse in the construction of another wall assembly.

14. The method of claim 13, wherein the first panel was secured to a side of the support member adjacent the second panel.

15. The method of claim 14, wherein the first panel was removed from engagement with the support member in a condition for reuse in the construction of another wall assembly.

16. The method of claim 13, further comprising removing the second panel, thereby exposing a space between a backside of a third panel and an outer surface of the support member.

17. The method of claim 16, wherein the third panel is secured to a side of the support member adjacent the second panel.

18. The method of claim 13, wherein the second panel is secured to the support member by an adhesive.

19. The method of claim 18, further comprising pulling the second panel away from the support member using the tool.

20. The method of claim 18, further comprising prying the second panel away from the support member using the tool.

21. A method of removing a wall assembly, wherein the wall assembly includes a first wall having a first panel, a second panel, and a third panel, wherein the wall assembly includes a second wall having a fourth panel and a fifth panel, and wherein the first and second walls are supported by and on opposite sides of a first support member, a second support member, and a third support member, the method comprising:
removing the first panel from the first support member, wherein the first panel forms a joint with the second panel that is secured to the first support member, wherein the second panel forms a joint with the third panel that is secured to the third support member, wherein the fourth panel forms a joint with the fifth panel that is secured to the second support member, and wherein the second support member is located between the first and second support members;
exposing a space between the fourth panel and the first support member, wherein the fourth panel is secured to the first support member on a side opposite the first and second panels;
introducing a tool into the space;
releasing the fourth panel from engagement with the first support member using the tool in a manner that the fourth panel is in a condition for reuse in the construction of another wall assembly; and
exposing the joint formed between the fourth panel and the fifth panel that is secured to the second support member.
